(19) United States
(12) Patent Application Publication
(10) Pub. No.: US 2025/0080379 A1
(43) Pub. Date: Mar. 6, 2025

(54) EDGE GATEWAY SYSTEM FOR PROVIDING DEVICE USE AND RESOURCE SHARING SUGGESTIONS AND OPERATING METHOD THEREOF

(71) Applicant: Electronics and Telecommunications Research Institute, Daejeon (KR)

(72) Inventors: Hee Do KIM, Daejeon (KR); Jae In KIM, Daejeon (KR); Geun Yong KIM, Daejeon (KR); Hark YOO, Daejeon (KR); Ryang Soo KIM, Daejeon (KR); Sung Chang KIM, Daejeon (KR); Chor Won KIM, Daejeon (KR); Ji Hyoung RYU, Daejeon (KR); Byung Hee SON, Daejeon (KR); Ki Cheoul WANG, Daejeon (KR); Gi Ha YOON, Daejeon (KR)

(73) Assignee: Electronics and Telecommunications Research Institute, Daejeon (KR)

(21) Appl. No.: 18/821,267

(22) Filed: Aug. 30, 2024

(30) Foreign Application Priority Data
Aug. 31, 2023 (KR) 10-2023-0115446

(51) Int. Cl. H04L 12/66; H04L 43/08; H04L 67/10

(52) U.S. Cl. CPC H04L 12/66; H04L 43/08; H04L 67/10

(57) ABSTRACT

Provided are an edge gateway system for providing device use and resource sharing suggestions and an operating method thereof. The edge gateway system includes at least one edge gateway and an edge gateway management server connected to the at least one edge gateway. The edge gateway is connected to one or more edge devices and transmits an operation status of the edge gateway and an operation status of the edge devices to the edge gateway management server, the edge gateway management server generates suggestion information to be delivered to a user of the edge gateway based on the operation status of the edge gateway and the operation status of the edge devices, and the suggestion information includes any one of an edge device use suggestion, an edge device sharing suggestion, and an edge gateway service resource sharing suggestion.

### CROSS-REFERENCE TO RELATED APPLICATION

This application claims priority to and the benefit of Korean Patent Application No. 10-2023-0115446, filed on Aug. 31, 2023, the disclosure of which is incorporated herein by reference in its entirety.

### BACKGROUND

### 1. Field of the Invention

The present invention relates to an edge gateway system and an operating method thereof.

### 2. Discussion of Related Art

Edge computing is a data processing paradigm that processes data generated from an end device in real time by a nearby server or the device where the data is generated rather than transmitting the data to a cloud. Through edge computing, server load and Internet bandwidth usage can be reduced, and response time can be shortened.

In edge computing, an edge gateway system is a device that is located between a central server and the end device, has an ability to implement basic computing, and performs necessary communication with the central server.

The edge gateway system generally includes one edge gateway management server, a plurality of edge gateways, and a plurality of devices.

In the edge gateway system, hardware and software resource management by conventional methods is accomplished by determining whether a device in operation is operating normally or in an abnormal state or providing services according to an explicit request of a device user.

That is, the conventional edge gateway system operates hardware and software resources in a way that compares the current system resource usage of devices with the standard system resource usage thereof to determine whether the device in operation is operating normally or in an abnormal state, or selects an appropriate user request recognition means to recognize a user after receiving data including various types of user requests through various devices and transmits the result of recognition of the user request to a control device to provide necessary services.

In this type of edge gateway system resource management method, only services explicitly requested by the user are provided. Therefore, the conventional edge gateway system has a problem in that utilization of resources such as hardware or software owned by the edge gateway system is often low because the conventional edge gateway system has no way to increase a utilization rate of new services as new devices appear or to utilize service resources that are in an idle state due to no user requests for other users.

### SUMMARY OF THE INVENTION

The present invention is directed to providing an edge gateway system and an operating method thereof that can actively perform resource management to increase the utilization of system resources.

Specifically, the present invention is directed to providing an edge gateway system and an operating method thereof that can suggest to use an edge gateway device or edge gateway service computation resource sharing to a user through a user interface based on type information of edge gateway devices, real-time usage of the device, and real-time usage of edge gateway service computation resources and provide compensation for the same.

The object of the present invention is not limited to the objects mentioned above, and other objects that are not mentioned will be clearly understood by those skilled in the art from the description below.

According to one embodiment of the present invention, there is provided an edge gateway system including at least one edge gateway and an edge gateway management server connected to the at least one edge gateway.

The edge gateway is connected to one or more edge devices and transmits an operation status of the edge gateway and an operation status of the edge devices to the edge gateway management server.

The edge gateway management server generates suggestion information to be delivered to a user of the edge gateway based on the operation status of the edge gateway and the operation status of the edge devices.

The suggestion information includes any one of an edge device use suggestion, an edge device sharing suggestion, and an edge gateway service resource sharing suggestion.

In one embodiment of the present invention, the edge gateway management server may generate compensation information to be provided to the user corresponding to the suggestion information when the user agrees to the suggestion information.

In one embodiment of the present invention, the operation status of the edge gateway includes a service resource usage amount of the edge gateway.

In one embodiment of the present invention, the operation status of the edge devices includes a usage amount of the edge devices.

In one embodiment of the present invention, the edge gateway management server distributes a software image required for servicing a target edge device to the edge gateway connected to the target edge device when the user agrees to the edge device use suggestion.

According to one embodiment of the present invention, there is provided an edge gateway management server including a gateway integrated management unit that monitors an operation status of one or more edge devices and an operation status of an edge gateway connected to the edge devices, a suggestion unit that generates suggestion information to be delivered to a user of the edge gateway based on the operation status of the edge gateway and the operation status of the edge devices, and a gateway communication unit that transmits the suggestion information to the edge gateway.

The suggestion information includes any one of an edge device user suggestion, an edge device sharing suggestion, and an edge gateway service resource sharing suggestion.

In one embodiment of the present invention, the edge gateway management server may further include a compensation management unit that generates compensation information to be provided to the user corresponding to the suggestion information when the user agrees to the suggestion information.

In one embodiment of the present invention, the operation status of the edge gateway includes a service resource usage amount of the edge gateway.

In one embodiment of the present invention, the operation status of the edge devices includes a usage amount of the edge devices.

In one embodiment of the present invention, the management server may further include an image management unit that distributes a software image required for servicing a target edge device to the edge gateway connected to the target edge device when the user agrees to the edge device use suggestion.

According to one embodiment of the present invention, there is provided an operating method of an edge gateway system including monitoring an operation status of an edge gateway, recognizing whether an edge device is in use based on the monitoring results, and transmitting a device use suggestion and compensation information corresponding to the device use suggestion to a user of an edge device that is not in use when the edge device that is not in use is present.

In one embodiment of the present invention, the operating method of the edge gateway system may further include checking whether a use request from another user for the edge device that is not in use is present, transmitting a device sharing suggestion for the edge device that is not in use and the compensation information corresponding to the of device sharing suggestion to the user of the edge device that is not in use when the use request from the another user for the edge device that is not in use is present, and approving the provision of compensation according to the compensation information when the user of the edge device that is not in use agrees to the device sharing suggestion.

In one embodiment of the present invention, an operation status of the edge gateway includes a service resource usage amount of the edge gateway.

In one embodiment of the present invention, the operating method of the edge gateway system may further include determining an edge gateway to be responsible for data analysis/processing for the edge device that is not in use based on monitoring results.

The above-described configurations and operations of the present invention will become more apparent from embodiments described in detail below with reference to the drawings.

### BRIEF DESCRIPTION OF THE DRAWINGS

The above and other objects, features and advantages of the present invention will become more apparent to those of ordinary skill in the art by describing exemplary embodiments thereof in detail with reference to the accompanying drawings, in which:

FIG. 1 is a diagram showing a configuration of an edge gateway system according to one embodiment of the present invention;

FIG. 2 is a block diagram showing a configuration of an edge gateway management server according to one embodiment of the present invention;

FIG. 3 is a block diagram showing a configuration of an edge gateway according to one embodiment of the present invention;

FIGS. 4A and 4B are diagrams for describing an example of how an edge gateway system performs a method of suggesting an edge device use to a user according to one embodiment of the present invention;

FIGS. 5A and 5B are diagrams for describing an example of how an edge gateway system performs a method of suggesting edge device sharing to a user according to one embodiment of the present invention;

FIGS. 6A and 6B are diagrams for describing an example of how an edge gateway system performs a method of suggesting edge gateway service resource sharing to a user according to one embodiment of the present invention;

FIG. 7 is a flowchart for describing an operating method of an edge gateway system according to one embodiment of the present invention; and

FIG. 8 is a block diagram showing a computer system for implementing an operating method of an edge gateway system according to one embodiment of the present invention.

### DETAILED DESCRIPTION OF EXEMPLARY EMBODIMENTS

Advantages and features of the present invention and methods for achieving them will be made clear from embodiments described in detail below with reference to the accompanying drawings. However, the present invention is not limited to the embodiments disclosed below and may be implemented in various different forms. These embodiments are merely provided so that this disclosure will be thorough and complete and will fully convey the scope of the present invention to those of ordinary skill in the technical field to which the present invention pertains, and the present invention is only defined by the scope of the claims. Meanwhile, terms used herein are for the purpose of describing the embodiments and are not intended to limit the present invention. As used herein, the singular forms also include the plural forms as well unless specifically stated otherwise in the context. The terms “comprise” and/or “comprising” used herein do not preclude the presence or addition of one or more other components, steps, operations and/or elements in addition to the mentioned components, steps, operations and/or elements.

In describing the present invention, when it is determined that a detailed description of related known technologies may unnecessarily obscure the gist of the present invention, the detailed description thereof will be omitted.

Hereinafter, embodiments of the present invention will be described in detail with reference to the accompanying drawings. In order to facilitate overall understanding in describing the present invention, the same reference numbers will be used for the same means regardless of the drawing numbers.

Generally, an edge gateway system includes a plurality of edge devices, a plurality of edge gateways, and an edge gateway management server. The edge gateway management server is connected to one or more edge gateways, and one or more edge devices are connected to each edge gateway.

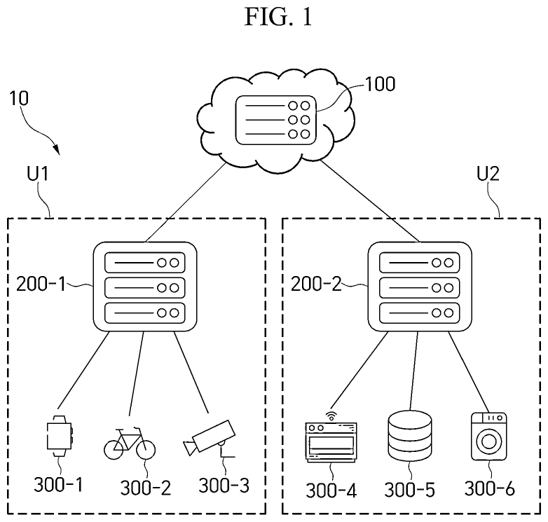

FIG. 1 is a diagram showing a configuration of an edge gateway system according to one embodiment of the present invention.

An edge gateway system 10 according to one embodiment of the present invention includes a management server 100 and one or more edge gateways 200. The edge gateway 200 is connected to one or more edge devices 300. For example, the edge gateway system 10 of FIG. 1 includes one edge gateway management server 100 (hereinafter abbreviated as “management server”) and two edge gateways 200-1 and 200-2, and six edge devices 300-1 to 300-6 are connected to the two edge gateways 200-1 and 200-2.

The edge gateway A (200-1) and the edge gateway B (200-2) are connected to the management server 100. An Ethernet, 5G or LTE mobile communication network, etc. in a wired or wireless manner may be used for the connection between the management server 100 and the edge gateways 200-1 and 200-2.

Three edge devices 300-1 to 300-3 are connected to the edge gateway A (200-1) and three edge devices 300-4 to 300-6 are also connected to the edge gateway B (200-2). As connection methods between the edge gateways 200-1 and 200-2 and edge devices 300-1 to 300-6, various wireless or wired communication methods such as Ethernet, low range radio (LoRA), ZigBee, serial communication, ModBus, Profibus, Profinet, Ethernet for control automation technology (EtherCAT), open platform communications unified architecture (OPC UA), etc. in a wired or wireless manner may be used. Examples of the edge devices 300-1 to 300-6 may include various sensors such as temperature and humidity meters, wattmeters, vibration meters, illuminance meters, pressure meters, anemometers, etc., cameras such as CCTV, infrared cameras, etc., home appliances such as TVs, washing machines, refrigerators, etc., smart devices such as smart electric bicycles, smartphones, smart watches, etc., and industrial equipment such as lathes, PLCs, etc.

In the embodiment of FIG. 1, the edge gateway A (200-1) and the edge devices 300-1 to 300-3 connected to the edge gatewayA (200-1) are used by a user A (U1), and the edge gateway B (200-2) and the edge devices 300-4 to 300-6 connected to the edge gateway B (200-2) are used by a user B (U2).

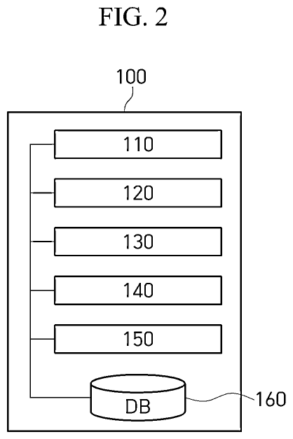

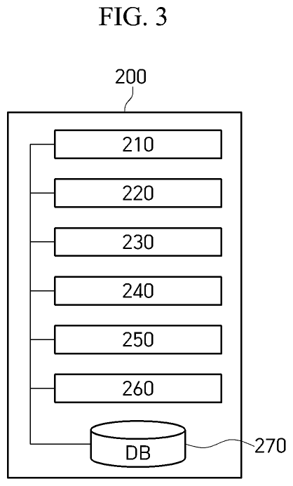

FIG. 2 is a block diagram showing a configuration of an edge gateway management server according to one embodiment of the present invention, and FIG. 3 is a block diagram showing a configuration of an edge gateway according to one embodiment of the present invention. Through the edge gateway management server 100 shown in FIG. 2 and the edge gateway 200 shown in FIG. 3, the edge gateway system 10 according to one embodiment of the present invention can improve the utilization of edge devices and service resources provided by the edge gateway.

Hereinafter, the configuration and functions of the management server 100 according to one embodiment of FIG. 2 will be described.

The management server 100 includes a gateway integrated management unit 110, an image management unit 120, a suggestion unit 130, a compensation management unit 140, a gateway communication unit 150, and a DB 160. The management server 100 shown in FIG. 2 corresponds to one embodiment, the components of the management server 100 according to the present invention are not limited to those of the embodiment shown in FIG. 2, and other components may be added thereto, or the components may be changed or omitted as needed.

The gateway integrated management unit 110 integrates and manages a plurality of edge gateways 200 connected to the management server 100. For example, the gateway integrated management unit 110 receives an operation status such as the service resource usage of a plurality of edge gateways 200, the usage of the edge device 300, etc. from the plurality of edge gateways 200 and continuously monitors the service resource usage and the usage of the edge device 300. Specifically, a gateway management unit 240 of each edge gateway 200 determines the operation status of the edge gateway 200 and one or more edge devices 300 connected to the edge gateway 200 and transmits the determination results to the management server 100 via a data delivery unit 220 and a server communication unit 250. The gateway integrated management unit 110 monitors the operation status of the edge gateway 200 and edge device 300 and recognizes whether each edge gateway 200 has insufficient resources or has idle resources, or recognizes whether the edge device 300 is in use.

The management server 100 operates one or more DBs 160. The DB 160 stores data measured or collected by the edge gateway, such as type information of the edge device 300 and real-time usage of the edge device 300 (may be abbreviated as “edge device usage” or “device usage”). In addition, the DB 160 stores data delivered from the edge gateway 200 or directly measured by the management server 100, such as the service resource usage/use rate of the edge gateway 200.

In addition, software images corresponding to various configurations and operating environments of the edge gateway 200 and the edge device 300 are stored and registered in the DB 160. The DB 160 also stores various types of pre-trained AI models required for the service of the edge gateway 200.

The DB 160 may be a relational database or a non-relational database depending on the type or characteristics of data managed by the edge gateway system 10.

The image management unit 120 selects an edge gateway software image (hereinafter abbreviated as “software image”) or an AI model corresponding to the request of the edge gateway 200 and distributes the software image or the AI model to the edge gateway 200.

The software image includes a configuration environment of the edge gateway 200 and an edge service corresponding to the request of the edge gateway 200. The configuration environment of the edge gateway 200 includes information such as the type and number of edge devices 300 connected to each edge gateway 200.

An edge gateway software image format may be a docker container or the like. The edge gateway 200 operates based on the software image or AI model distributed from the management server 100.

The suggestion unit 130 generates suggestion information to be transmitted to a user of the edge gateway 200 based on the operation status of the edge gateway 200 and the operation status of the edge device 300. The suggestion unit 130 suggests to use an appropriate device/service to the user or suggests edge gateway idle resource sharing to the user based on the monitoring results of the gateway integrated management unit 110, such as edge device usage amount (hereinafter abbreviated as “device usage”), edge gateway service resource usage amount (hereinafter abbreviated as “service resource usage”), type information of the edge device 300, and/or the configuration and operating environment of the edge gateway. For example, the suggestion unit 130 may suggest to use the edge device 300 registered in the edge gateway 200 of the user but with zero usage or a newly released edge device 300 that has not yet been registered in the edge gateway 200 of the user to the user.

In addition, as another example, when the edge gateway 200 that manages a specific edge device 300 has insufficient resources, the suggestion unit 130 may suggest idle resource sharing to the user of the edge gateway 200 that has idle resources among other edge gateways 200 that can service the edge device 300 of the same type (determined by the type information).

The suggestion unit 130 may present certain compensation to the user when suggesting to use a device, use a service, or share edge gateway idle resources.

The compensation management unit 140 manages the compensation provided to a user who agrees to the device use suggestion, service use suggestion, or edge gateway idle resource sharing suggestion of the suggestion unit 130. For example, the compensation management unit 140 determines the details of the compensation (e.g., type and amount of compensation, date of provision of compensation, validity period of compensation, etc.) and provides the details of the compensation to the suggestion unit 130, and manages the details of the compensation when the user agrees to the suggestion. The compensation to be presented to a user may be of various types, such as points, rate reductions, gift certificates, or device usage rights. The amount of compensation may vary depending on the value provided by the user. For example, the amount of compensation may be determined based on the value of the device or resources of the user to be shared.

The gateway communication unit 150 transmits and receives data to and from the edge gateway 200 through a wired or wireless network. For example, the gateway communication unit 150 transmits the suggestion information generated by the suggestion unit 130 to the server communication unit 250 of the edge gateway 200, or receives operation status information of the edge gateway 200 or edge device 300 from the server communication unit 250 of the edge gateway 200.

The gateway communication unit 150 transmits data received from the edge gateway 200 to each component of the management server 100. For example, the gateway communication unit 150 may deliver the operation status information of the edge gateway 200 or edge device 300 received from the server communication unit 250 to the gateway integrated management unit 110.

In the present invention, there are no restrictions on a communication method between the management server 100 and the edge gateway 200.

Hereinafter, the configuration and functions of the edge gateway 200 according to one embodiment of FIG. 3 will be described.

The edge gateway 200 includes a device control unit 210, the data delivery unit 220, a data analysis/processing unit 230, the gateway management unit 240, the server communication unit 250, a user interface unit 260, and a DB 270. The edge gateway 200 shown in FIG. 3 corresponds to one embodiment, the components of the edge gateway 200 according to the present invention are not limited to those of the embodiment shown in FIG. 3, and other components may be added thereto, or the components may be changed or omitted as needed.

The device control unit 210 is responsible for an interface function with the edge device 300 connected to the edge gateway 200. The device control unit 210 transmits and receives data required for device control to and from the edge device 300 and transmits control commands for controlling the edge device 300 to each edge device 300. In addition, the device control unit 210 receives data acquired by the edge device 300.

As a communication method for transmitting and receiving data between the device control unit 210 and the edge device 300, communication using IoT protocols such as Ethernet, ZigBee, Bluetooth, and message queuing telemetry transport (MQTT), serial communication such as RS232 and RS485, industrial fieldbuses such as ModBus and Profinet, and industrial Ethernet such as ModBusTCP and EtherCAT in a wired and wireless manner may be used. However, in the present invention, the communication method between the device control unit 210 and the edge device 300 is not limited to the above-described example.

The data delivery unit 220 performs a data delivery function between functional blocks (components) of the edge gateway 200. For example, the data delivery unit 220 stores data received from the edge device 300 in the DB 270 or transmits the data stored in the DB 270 to the data analysis/processing unit 230.

The data analysis/processing unit 230 performs computations required for various services for devices connected to the edge gateway based on data read from the DB 270. For example, the data analysis/processing unit 230 performs inference using an AI model based on data extracted from the DB 270.

The gateway management unit 240 monitors the service resource usage of the data analysis/processing unit 230, the usage of the edge device 300 connected to the edge gateway 200, etc., and stores the monitoring results in the DB 270. In addition, the gateway management unit 240 transmits the operation status of the edge gateway 200 and edge devices 300 connected to the edge gateway 200 to the management server 100 via the data delivery unit 220 and the server communication unit 250 based on the monitoring results. The operation status includes the service resource usage of the edge gateway 200 and the usage of the edge device 300. In addition, the gateway management unit 240 may transmit type information of the edge device 300 connected to the edge gateway 200 to the management server 100 via the data delivery unit 220 and the server communication unit 250.

The server communication unit 250 is responsible for a connection function with the management server 100. The server communication unit 250 connects each edge device 300 connected to the edge gateway 200 or each functional block of the edge gateway 200 with the management server 100. As a communication method for a physical connection between the server communication unit 250 and the management server 100, Ethernet, LTE, or 5G mobile communication in a wired or wireless manner may be used. However, in the present invention, there is no limitation on the communication method between the server communication unit 250 and the management server 100.

The user interface unit 260 delivers suggestion information (content of the suggestion) of the management server 100 to the user. For example, the user interface unit 260 delivers the device use suggestion or resource sharing suggestion to the user along with compensation content. There may be various methods by which the user interface unit 260 delivers suggestions and compensation to the user, such as auditory and visual. As another example, the device use suggestion or the resource sharing suggestion and the compensation content corresponding to the suggestion may be delivered to the user through means such as a phone call or email, rather than through the user interface unit 260.

The DB 270 stores data collected by the edge device 300, computation results of the data analysis/processing unit 230, and monitoring results and determination results of the gateway management unit 240. For example, the DB 270 may store data such as temperature, vibration, and power usage collected by the edge device 300. The DB 270 may be a relational database or a non-relational database depending on the type or characteristics of data to be managed.

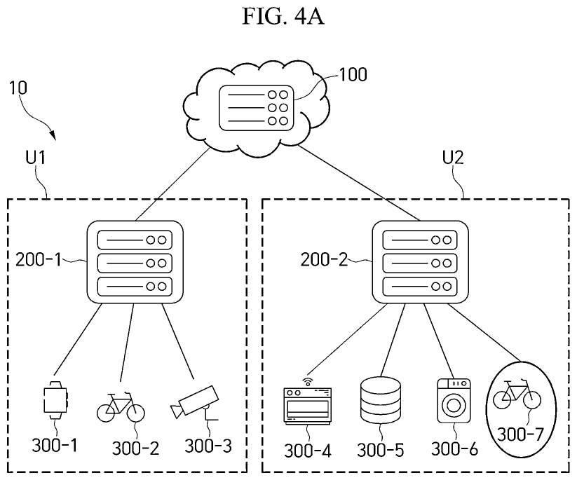

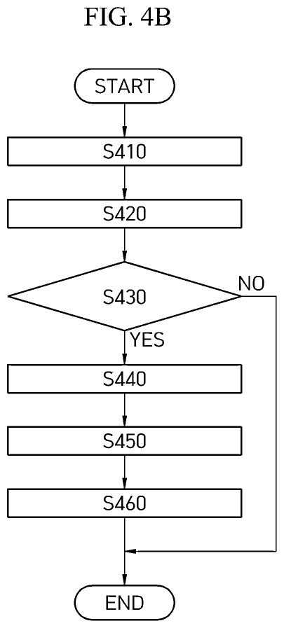

FIGS. 4 to 6 are diagrams for describing an example of how the edge gateway system performs a method of suggesting an edge device use, a method of suggesting edge device sharing, and a method of suggesting edge gateway service resource sharing according to one embodiment of the present invention. The configuration of FIGS. 4A, 5A, and 6A is basically the same as that of FIG. 1, with the only difference being that in FIG. 4A, an edge device G (300-7) is additionally connected to the edge gateway B (200-2).

FIGS. 4A and 4B are diagrams for describing an example of how an edge gateway system performs a method of suggesting an edge device use to a user according to one embodiment of the present invention. FIG. 4A is a configuration diagram of an edge gateway system, and FIG. 4B is a flowchart for describing a method of suggesting an edge device use to a user. The method of suggesting the edge device use to the user according to one embodiment of the present invention corresponds to one of the edge gateway system operating methods and includes operations S410 to S460.

Operation S410 is an operation of monitoring whether the device is in use. The gateway integrated management unit 110 of the management server 100 monitors the operation status of the edge gateway 200 and recognizes whether each edge device 300 connected to the edge gateway 200 is in use based on the monitoring results. For example, the management server 100 monitors the operation status of the edge gateway B (200-2) and recognizes that the user B is not using the edge device G (300-7) based on the monitoring results. The edge device G (300-7) may be a device that is registered in the edge gateway 200-2 but is not actually in use, a newly released device, or a device that has not been registered in the edge gateway 200-2 due to a user who did not register the device.

Operation S420 is an operation of suggesting a device use to a user who is not using the device. The suggestion unit 130 of the management server 100 generates a device use suggestion targeted for a user who is not using the device based on the operating environment of the edge gateway 200 and the monitoring results of the gateway integrated management unit 110. The suggestion unit 130 delivers the device use suggestion and compensation information to the user through the edge gateway 200. For example, the suggestion unit 130 of the management server 100 generates a suggestion about recommending the use of the edge device G (300-7), which is targeted for the user B, based on the operating environment of the edge gateway B (200-2) connected to the edge device G (300-7) and the monitoring results of the gateway integrated management unit 110 (the edge device G (300-7) is not in use). In addition, the suggestion unit 130 requests compensation information to be provided to the user B from the compensation management unit 140. The compensation management unit 140 generates compensation information to be provided to the user B for use of the edge device G (300-7) and transmits the compensation information to the suggestion unit 130. The suggestion unit 130 suggests the use of the edge device G (300-7) and compensation for the same to the user B via the gateway communication unit 150, a server communication unit 250-2, and a user interface unit 260-2. The edge device use suggestion and the compensation content are delivered to the user B through the user interface unit 260-2 of the edge gateway B (200-2). The device use suggestion and the compensation content may be expressed in various ways, such as audibly or visually, through the user interface unit 260-2 of the edge gateway B (200-2), or may be provided to the user B through a separate means such as a phone call or email.

Operation S430 is an operation of checking whether the user agrees to the suggestion. The suggestion unit 130 approves compensation when the user agrees to the suggestion (S440). For example, when the user B agrees to the suggestion to use the edge device G (300-7), the suggestion unit 130 approves the provision of compensation for the same.

Operation S450 is an operation of distributing a service image to the edge gateway. When the user agrees to the edge device use suggestion, the image management unit 120 of the management server 100 distributes the software image, AI model, or data required for the service of the edge device 300 to the edge gateway 200.

Operation S460 is an operation in which the edge gateway activates the service for the corresponding device. The edge gateway 200 connected to an edge device 300 that is not in use activates a service for the edge device 300 that is not in use.

For example, in operations S450 and S460, the image management unit 120 distributes the software image, AI model and data required for the service of the edge device G (300-7) to the edge gateway 200-2 through the server communication unit 250-2 and the server communication unit 250-2, and the edge gateway 200-2 activates a service for the edge device G (300-7) using the distributed software image, AI model, and data. That is, a device control unit 210-2 controls the edge device G (300-7), and a data analysis/processing unit 230-2 performs computations required for the service using distributed data or data read from the DB 270. The data read from DB 270 may include data acquired by the edge device G (300-7).

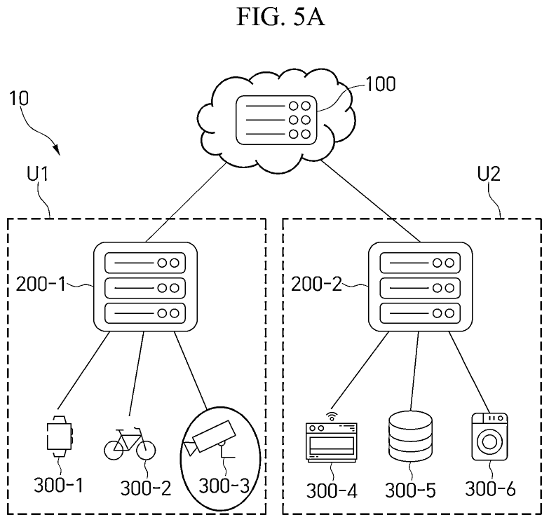

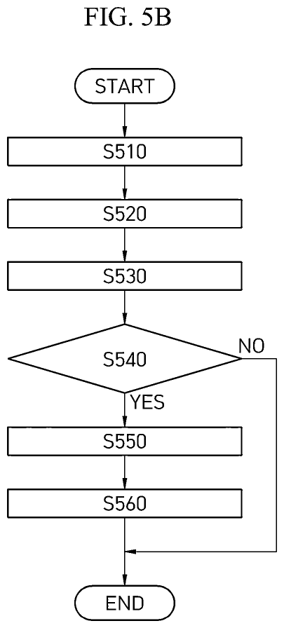

FIGS. 5A and 5B are diagrams for describing an example of how an edge gateway system performs a method of suggesting edge device sharing to a user according to one embodiment of the present invention. FIG. 5A is a configuration diagram of an edge gateway system, and FIG. 5B is a flowchart for describing a method of suggesting edge device sharing. The method of suggesting edge device sharing according to one embodiment of the present invention corresponds to one of the operating methods of the edge gateway system and includes operations S510 to S560.

Operation S510 is an operation of monitoring whether the device is in use. The management unit 110 of the management server 100 monitors the operation status of the edge gateway 200 and recognizes whether each edge device 300 connected to the edge gateway 200 is in use based on the monitoring results. For example, when the edge device C (300-3) connected to the edge gatewayA (200-1) of the user A is in an idle state, the gateway integrated management unit 110 may recognize that the edge device C (300-3) connected to the edge gatewayA (200-1) is in an idle state based on the monitoring results of the operation status of the edge gatewayA (200-1) and the edge gateway B (200-2).

Operation S520 is an operation of monitoring the presence or absence of demand (request for use) from other users for a device that is not in use. The gateway integrated management unit 110 monitors a device use request of a user. For example, the user B may need to use a CCTV (the edge device C (300-3)) that is not being used by the user A for a certain period of time in order to monitor a specific region. The user B may deliver a request to use some or all of the functions of the edge device C (300-3) connected to the edge gatewayA (200-1) of the userA to the management server 100 via the user interface unit 260-2, the server communication unit 250, and the gateway communication unit 150. In this case, the gateway integrated management unit 110 recognizes a request to use the edge device C (300-3) of the user B.

The request to use the edge device C (300-3) may further include the type information of the edge device 300 to be used.

Operation S530 is an operation of suggesting device sharing to a user who is not using the device. The suggestion unit 130 may generate a device sharing suggestion for a user who is not using the device based on the monitoring result and use request recognition result of the gateway integrated management unit 110. For example, the suggestion unit 130 generates a suggestion to share edge device C (300-3), which is targeted for the user A, based on the operating environment of the edge gateway A (200-1) connected to the edge device C (300-3), a request to use the edge device C (300-3) of the user B, and the monitoring results (the edge device C (300-3) is in an idle state) of the gateway integrated management unit 110. In this case, the suggestion unit 130 may consider information such as a distance between the edge gatewayA (200-1) and the edge gateway B (200-2) or a distance between the user A and the user B when generating an edge device sharing suggestion. In addition, the suggestion unit 130 requests compensation information to be provided to the user A from the compensation management unit 140. The compensation management unit 140 generates compensation information to be provided to the user A for sharing the edge device C (300-3) and delivers the compensation information to the suggestion unit 130. The suggestion unit 130 suggests sharing the edge device C (300-3) and compensation for the same to the user A via the gateway communication unit 150, the server communication unit 250-1, and the user interface unit 260-1. The resource sharing suggestion and compensation content are delivered to the userA through the user interface unit 260-1 of the edge gatewayA (200-2).

Operation S540 is an operation of checking whether the user agrees to the suggestion. The suggestion unit 130 approves compensation when the user agrees to the suggestion (S550).

For example, when the user A agrees to the suggestion to share edge device C (300-3), the suggestion unit 130 approves the provision of compensation to the user A.

Operation S560 is an edge device activating operation. When the user A agrees to the suggestion to share edge device C (300-3), data analysis/processing for edge device C (300-3) may be performed by the edge gateway A (200-1) or edge gateway B (200-2) depending on the situation. The gateway integrated management unit 110 may determine the edge gateway 200 responsible for data analysis/processing for the edge device C (300-3) according to the monitoring results of the operation status of the edge gateway A (200-1) or edge gateway B (200-2). When the resources of the edge gateway A (200-1) (e.g., a graphics processing unit (GPU) of a data analysis/processing unit 230-2) are used for data analysis/processing for the edge device C (300-3), the usage of the corresponding resources is reflected in the compensation for the user A. The service results of the edge device C (300-3) are expressed through the user interface 260-2 of the edge gateway B (200-2), which is an edge gateway of the user B.

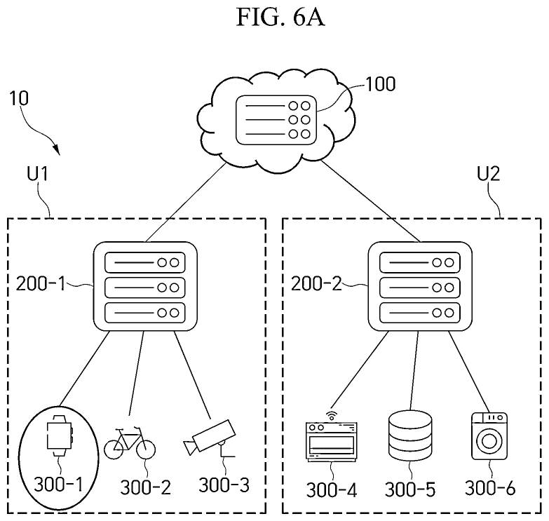

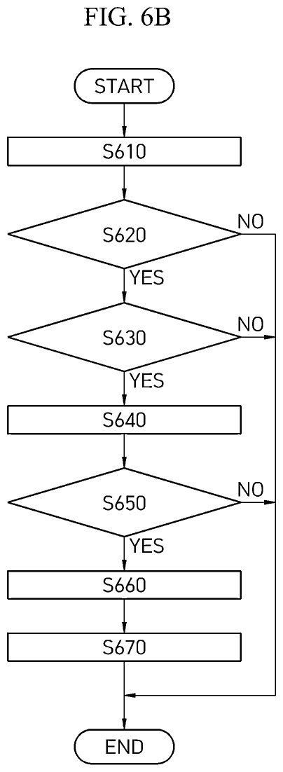

FIGS. 6A and 6B are diagrams for describing an example of how an edge gateway system performs a method of suggesting edge gateway service resource sharing to a user according to one embodiment of the present invention. FIG. 6A is a configuration diagram of an edge gateway system, and FIG. 6B is a flowchart illustrating a method of suggesting edge gateway service resource sharing. The method of suggesting edge gateway service resource sharing according to one embodiment of the present invention corresponds to one of the edge gateway system operating methods and includes operations S610 to S670.

Operation S610 is an operation of monitoring a computation resource use status of the edge gateway. The gateway integrated management unit 110 of the management server 100 monitors the operation status of the edge gateway 200.

Operation S620 is an operation of determining whether computation resources are insufficient. The management unit 110 determines whether computation resources for the service of the edge device 300 are insufficient based on the monitoring results of the operation status of the edge gateway 200. The management server 100 proceeds to operation S630 when an edge gateway 200 that lacks computation resources is present among the edge gateways 200. For example, the gateway integrated management unit 110 monitors the operation status of the edge gatewayA (200-1) and determines that the edge gateway A (200-1) lacks data analysis processing resources (e.g., GPU resources) for the edge device A (300-1).

Operation S630 is an operation of determining whether idle computation resources are present. The gateway integrated management unit 110 determines whether idle computation resources are present among the computation resources of the edge gateway 200 based on the monitoring results the operation status of the edge gateway 200. When the idle computation resources are present, the management server 100 proceeds to operation S640. For example, the gateway integrated management unit 110 may monitor the operation status of the edge gateway 200 and recognize that idle resources for data analysis processing are present in the edge gateway B (200-2).

Operation S640 is an operation of suggesting idle resource sharing to the user. The gateway integrated management unit 110 delivers the monitoring results and determination results to the suggestion unit 130. The suggestion unit 130 generates a resource sharing suggestion to use the idle computation resources of the edge gateway 200 for the edge device 300 based on the monitoring results and/or determination results of the gateway integrated management unit 110. For example, the suggestion unit 130 generates a resource sharing suggestion to use the idle computation resources of the edge gateway B (200-2) for the edge device A (300-1) based on the monitoring results of the gateway integrated management unit 110.

The suggestion unit 130 may request compensation information to be presented to the user from the compensation management unit 140 and suggest the compensation information provided by the compensation management unit 140 to the user along with the resource sharing suggestion.

For example, the suggestion unit 130 requests compensation information to be suggested to the user B of the edge gateway B (200-2) from the compensation management unit 140. The compensation management unit 140 provides appropriate compensation information to be presented to the user B to the suggestion unit 130 according to the request of the suggestion unit 130. The suggestion unit 130 suggests sharing some or all of the computation resources of the data analysis/processing unit 230-2 of the edge gateway B (200-2) and compensation for the same to the user B via the gateway communication unit 150, the server communication unit 250-2, and the user interface unit 260-2. The resource sharing suggestion and the compensation content are delivered to the user B through the user interface unit 260-2 of the edge gateway B (200-2).

The suggestion to share service resources of the edge gateway B (200-2) and compensation content for the same may be expressed in various ways, such as auditory or visual, through the user interface unit 260-2 of the edge gateway B (200-2), and may be provided to the user B through separate means such as a phone call or email.

Operation S650 is an operation of checking whether the user agrees to the resource sharing suggestion. The suggestion unit 130 approves compensation when the user agrees to the suggestion (S660).

For example, when the user B agrees to the suggestion to share resources of the edge gateway B (200-2), the suggestion unit 130 approves the provision of compensation to the user B.

Operation S670 is a data delivery and processing operation for the service. The edge gateway 200 in charge of the target edge device 300 delivers data for the operation of the target edge device 300 to the edge gateway 200 having idle resources. For example, the edge gateway A (200-1) delivers some or all of data for the edge device A (300-1) to the edge gateway B (200-2), and idle computation resources of the data analysis/processing unit 230-2 of the edge gateway B (200-2) are used as computation resources for the edge device A (300-1) of the user A.

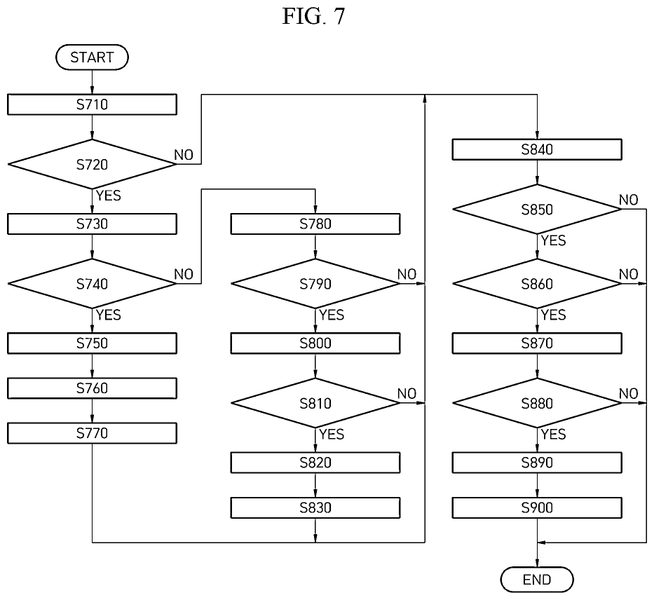

FIG. 7 is a flowchart for describing an operating method of an edge gateway system according to one embodiment of the present invention. The operating method of an edge gateway system according to one embodiment of the present invention includes operations S710 to S900.

The embodiment of FIG. 7 is one embodiment that comprehensively describes the operating methods of the edge gateway system of FIGS. 4 to 6, and the details of each operation will be understood by referring to the descriptions of FIGS. 4 to 6. That is, the description referring to FIGS. 4 to 6 may be included in the description of the embodiment of FIG. 7.

The gateway integrated management unit 110 of the management server 100 monitors an operation status of the edge gateway 200, and recognizes whether each edge device 300 connected to the edge gateway 200 is in use based on the monitoring results (S710). The gateway integrated management unit 110 determines whether an edge device 300 that is not in use is present, and when the edge device 300 that is not in use is present, the gateway integrated management unit 110 proceeds to operation S730, otherwise, proceeds to operation S840 (S720). When the edge device 300 that is not in use is present, the suggestion unit 130 transmits an edge device use suggestion and compensation information to the user of the corresponding edge device 300 through the edge gateway 200 (S730). The suggestion unit 130 approves the provision of compensation when the user agrees to the suggestion (S740 and S750). When the user does not agree to the suggestion, operation S780 is performed. When the user agrees to the edge device use suggestion, the image management unit 120 of the management server 100 distributes a software image, AI model or data required for service of the edge device 300 to the edge gateway 200 (S760). The edge gateway 200 connected to an edge device 300 that is not in use activates a service for the corresponding edge device 300 that is not in use (S770).

When the user does not agree to the suggestion to use the edge device 300 that is not in use, the gateway integrated management unit 110 monitors whether there is a request to use a target edge device 300 from another user (S780). The gateway integrated management unit 110 proceeds to operation S840 when there is no request to use the target edge device 300 from another user, and proceeds to operation S800 when there is a request to use the target edge device 300 (S790). The suggestion unit 130 suggests device sharing to a user who is not using the device based on the monitoring results and uses request recognition results of the gateway integrated management unit 110 (S800). The suggestion unit 130 checks whether the user agrees to the suggestion (S810). The suggestion unit 130 approves the compensation when the user agrees to the suggestion (S820), and otherwise, the suggestion unit 130 proceeds to operation S840. When the user agrees to the suggestion, the edge device 300 that is not in use may be activated (S830).

When no edge device 300 that is not in use is present or there is no request to use the edge device 300 that is not in use from another user or the user rejects the device sharing suggestion even when the edge device 300 that is not in use is present, operation S840 is performed.

The gateway integrated management unit 110 of the management server 100 monitors the operation status of the edge gateway 200 (S840) and determines whether computation resources are insufficient (S850). When an edge gateway 200 that lacks computation resources is present, the gateway integrated management unit 110 determines whether idle computation resources are present among the computation resources of other edge gateways 200 (S860). When idle computation resources are present in other edge gateways 200, the gateway integrated management unit 110 proceeds to operation S870. The gateway integrated management unit 110 delivers the monitoring results and determination results to the suggestion unit 130. The suggestion unit 130 generates a resource sharing suggestion to use the idle computation resources of the edge gateway 200 for the edge device 300 based on the monitoring results and/or determination results of the gateway integrated management unit 110, and suggests resource sharing to a user of another edge gateway 200 having idle computation resources (S870). The suggestion unit 130 may present a corresponding compensation to the user along with the resource sharing suggestion. When the user who received the suggestion agrees to the suggestion (S880), compensation is approved (S890), and the edge gateway 200 in charge of the target edge device 300 delivers data for the operation of the target edge device 300 to the edge gateway 200 having idle resources (S900).

The operating method of the edge gateway system shown in FIGS. 4 to 7 corresponds to one embodiment, and the operations of the operating method of the edge gateway system according to the present invention are not limited to those of the embodiment shown in FIGS. 4 to 6, and other operations may be added thereto, or the operations may be changed or omitted as needed.

The above-described operating method of the edge gateway system has been described with reference to the flowchart shown in the drawings. For simplicity of description, the method is shown and described as a series of blocks, however, the present invention is not limited to the order of the blocks. Some blocks may be performed simultaneously or in a different order than shown and described herein with other blocks, and various other branches, flow paths, and sequences of blocks that achieve the same or similar results may be implemented. In addition, not all blocks shown may be required for implementation of the methods described herein.

Meanwhile, in the description with reference to FIGS. 4 to 7, each operation may be further divided into additional operations or may be combined into fewer operations, depending on the implementation of the present invention. In addition, some operations may be omitted or the order between operations may be changed as needed. In addition, even if other omitted contents are included, the contents of FIGS. 4 to 7 may be applied to the contents of FIGS. 1 to 3. In addition, the contents of FIGS. 1 to 3 may be applied to the contents of FIGS. 4 to 7.

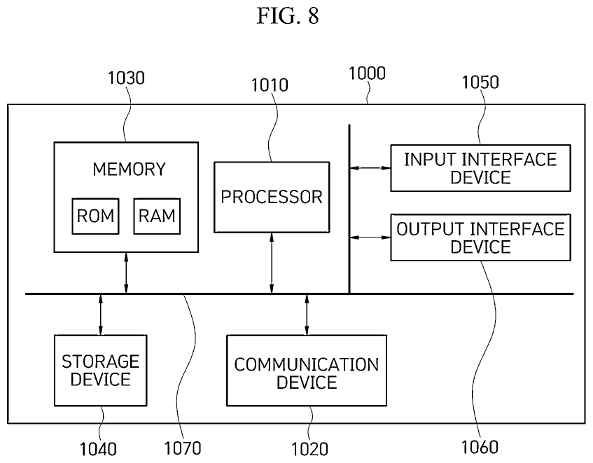

FIG. 8 is a block diagram showing a computer system for implementing an operating method of an edge gateway system according to one embodiment of the present invention. The management server 100 and/or the edge gateway 200 according to one embodiment of the present invention may be implemented in the same form as the computer system of FIG. 8.

Referring to FIG. 8, a computer system 1000 may include at least one of a processor 1010, a memory 1030, an input interface device 1050, an output interface device 1060, and a storage device 1040 that communicate with each other through a bus 1070. The computer system 1000 may also further include a communication device 1020 coupled to a network. The processor 1010 may be a central processing unit (CPU) or a semiconductor device that executes instructions stored in the memory 1030 or the storage device 1040. The memory 1030 and the storage device 1040 may include various forms of volatile or nonvolatile storage media. For example, the memory may include a read only memory (ROM) and a random access memory (RAM). In the embodiments described herein, the memory may be located inside or outside the processor, and the memory may be connected to the processor through various means known in the art. The memory may include various forms of volatile or nonvolatile storage media, and for example, the memory may include a ROM or a RAM.

Accordingly, embodiments of the present invention may be implemented as a method implemented in a computer, or as a non-transitory computer-readable medium having computer-executable instructions stored thereon. In one embodiment, the computer-readable instructions, when executed by a processor, may cause the processor to perform a method according to at least one aspect of the present disclosure.

The communication device 1020 may transmit or receive wired or wireless signals.

In addition, the method according to the embodiment of the present invention may be implemented in the form of program instructions that can be executed through various computer means and recorded on a computer-readable medium.

The computer-readable medium may include program instructions, data files, data structures, etc., alone or in combination. The program instructions recorded on the computer-readable medium may be specially designed and configured for the embodiment of the present invention, or may be known and available to those skilled in the art of computer software. The computer-readable recording medium may include a hardware device configured to store and execute the program instructions. For example, the computer-readable recording medium may be a hard disk, a magnetic media such as a floppy disk and a magnetic tape, an optical media such as a compact disc ROM (CD-ROM) or a digital versatile disc (DVD), a magneto-optical media such as a floptical disk, a ROM, a RAM, a flash memory, etc. The program instructions may include not only machine language code generated by a compiler, but also high-level language code that can be executed by a computer through an interpreter, etc.

The conventional edge gateway system monitors an operation status of an edge gateway or device currently in use, compares a current usage rate with a reference usage rate of the device or edge gateway service resources based on the monitoring results to determine only an abnormal state of the edge gateway or device, or provides services in response only to an explicit request from a device user, and does not provide functions to improve the utilization of edge gateway system resources through using or sharing the device and edge gateway service resources.

According to the present invention, there is an effect of not only being able to determine whether a device is abnormal based on information such as device information, the usage of the device and edge gateway service resources, etc. and respond to the explicit request of the user, but also increasing the utilization of devices and services provided by the edge gateway system through functions of suggesting the device/service use and suggesting resource sharing, and of providing compensation.

The effects that can be obtained from the present invention are not limited to the effects mentioned above, and other effects that are not mentioned will be clearly understood by those skilled in the art to which the present invention pertains from the following description.

Although the present invention has been described above with reference to preferred embodiments thereof, those skilled in the art will appreciate that various modifications and changes may be made thereto without departing from the spirit and scope of the present invention as set forth in the claims below.

### LIST OF REFERENCE NUMERALS

10: edge gateway system
100: management server
110: gateway integrated management unit
120: image management unit
130: suggestion unit
140: compensation management unit
150: gateway communication unit
160: DB
270: DB
200: edge gateway
210: device control unit
220: data delivery unit
230: data analysis/processing unit
240: gateway management unit
250: server communication unit
260: user interface unit
270: DB
300: edge device
1000: computer system
1010: processor
1020: communication device
1030: memory
1040: storage device
1050: input interface device
1060: output interface device
1070: bus

What is claimed is:

1. An edge gateway system comprising:
at least one edge gateway; and
an edge gateway management server connected to the at least one edge gateway,
wherein the edge gateway is connected to one or more edge devices and transmits an operation status of the edge gateway and an operation status of the edge devices to the edge gateway management server,
the edge gateway management server generates suggestion information to be delivered to a user of the edge gateway based on the operation status of the edge gateway and the operation status of the edge devices, and
the suggestion information includes any one of an edge device use suggestion, an edge device sharing suggestion, and an edge gateway service resource sharing suggestion.

2. The edge gateway system of claim 1, wherein the edge gateway management server generates compensation information to be provided to the user corresponding to the suggestion information when the user agrees to the suggestion information.

3. The edge gateway system of claim 1, wherein the operation status of the edge gateway includes a service resource usage amount of the edge gateway.

4. The edge gateway system of claim 1, wherein the operation status of the edge devices includes a usage amount of the edge devices.

5. The edge gateway system of claim 1, wherein the edge gateway management server distributes a software image required for servicing a target edge device to the edge gateway connected to the target edge device when the user agrees to the edge device use suggestion.

6. An edge gateway management server comprising:
a memory configured to store computer-readable instructions; and
at least one processor configured to execute the instructions,
wherein the at least one processor is configured to monitor an operation status of one or more edge devices and an operation status of an edge gateway connected to the edge devices,
generate suggestion information to be delivered to a user of the edge gateway based on the operation status of the edge gateway and the operation status of the edge devices, and
transmit the suggestion information to the edge gateway,
wherein the suggestion information includes any one of an edge device use suggestion, an edge device sharing suggestion, and an edge gateway service resource sharing suggestion.

7. The edge gateway management server of claim 6, wherein the at least one processor is configured to additionally perform an operation of generating compensation information to be provided to the user corresponding to the suggestion information when the user agrees to the suggestion information.

8. The edge gateway management server of claim 6, wherein the operation status of the edge gateway includes a service resource usage amount of the edge gateway.

9. The edge gateway management server of claim 6, wherein the operation status of the edge devices includes a usage amount of the edge devices.

10. The edge gateway management server of claim 6, wherein the at least one processor is configured to additionally perform an operation of distributing a software image required for servicing a target edge device to the edge gateway connected to the target edge device when the user agrees to the edge device use suggestion.

11. An operating method of an edge gateway system, comprising:
monitoring an operation status of an edge gateway;
recognizing whether an edge device is in use based on the monitoring results; and
transmitting a device use suggestion and compensation information corresponding to the device use suggestion to a user of an edge device that is not in use when the edge device that is not in use is present.

12. The operating method of claim 11, further comprising:
checking whether a use request from another user for the edge device that is not in use is present;
transmitting a device sharing suggestion for the edge device that is not in use and the compensation information corresponding to the device sharing suggestion to the user of the edge device that is not in use when the use request from the another user for the edge device that is not in use is present; and
approving provision of compensation according to the compensation information when the user of the edge device that is not in use agrees to the device sharing suggestion.

13. The operating method of claim 11, wherein an operation status of the edge gateway includes a service resource usage amount of the edge gateway.

14. The operating method of claim 12, further comprising determining an edge gateway to be responsible for data analysis/processing for the edge device that is not in use based on monitoring results.
